(19) United States
(12) Patent Application Publication
(10) Pub. No.: US 2005/0104492 A1
(43) Pub. Date: May 19, 2005

(54) Track positioning device for a drawer

(76) Inventor: Susan Chiu, Kaohsiung (TW)

Correspondence Address: VENABLE, BAETJER, HOWARD AND CIVILETTI, LLP, P.O. BOX 34385, WASHINGTON, DC, 20043-9998, US

(21) Appl. No.: 10/712,109

(22) Filed: Nov. 14, 2003

(51) Int. Cl. B30B 1/00

(52) U.S. Cl. 312/333

(57) ABSTRACT

A track positioning device for a drawer includes a positioning block which includes a body with a positioning slot defined therein, two opposite wings and an extending plate, a stop formed and extended into the positioning slot, a positioning hole defined in the body to communicate with the positioning slot, wherein the extending plate has two plates and a guiding recess is defined between the plate and the extending plate, two first hooks are respectively formed on opposite sides of the extending plate, a moving block which has an extension and a second hook and a spring which is provided between the positioning block and the moving block and has a first distal end securely connected to one of the first hooks and a second distal end to be securely connected to the second hook via the guiding recess.

### BACKGROUND OF THE INVENTION

1. Field of the Invention

The present invention relates to a track positioning device, and more particularly to track positioning device for a drawer to facilitate the positioning and movement of the drawer.

2. Description of Related Art

Normally, a positioning device is employed to a drawer to facilitate the movement and positioning of the drawer. One kind of the conventional positioning device usually has a Y-shaped slot defined in the track and an extension slidably received in first and second positions in the Y-shaped slot such that when the extension is received in the first position in the Y-shaped slot, the movement of the drawer is temporarily limited and when the extension is received in the second position in the Y-shaped slot, the movement of the drawer is facilitated. To make this conventional positioning device work, a lot of energy will be involved in that the operator has to apply a great deal of effort to overcome the design of the Y-shaped slot, which causes a lot of inconvenience.

Another conventional track positioning device uses a mechanism including therein a spring so that the movement of the drawer is facilitated for only a small amount of effort from the operator is required to operate the movement of the drawer. However, the mechanism is complicated and complex so that the manufacturing cost is high and thus the maintenance is difficult.

To overcome the shortcomings, the present invention tends to provide an improved track positioning device to mitigate the aforementioned problems.

### SUMMARY OF THE INVENTION

The primary objective of the present invention is to provide an improved track positioning device for facilitating the positioning of the drawer.

Another objective of the present invention is to provide an improved track positioning device for easy movement of the drawer.

In order to accomplish the aforementioned objectives, the track positioning device includes an inner track, an outer track slidably connected to the inner track and a mediate track slidable relative to the inner track and the outer track, wherein the mediate track is slidably connected to the outer track. The mediate track has an arcuate slot defined to communicate with the positioning slot defined in the positioning block which is firmly connected to the inner track. The positioning block further has a positioning hole defined to communicate with the positioning slot such that the extension of a moving block is able to be alternatively positioned in the positioning hole while the mediate track is movable relative to both the inner track and the outer track.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the track positioning device of the present invention;

FIG. 2 is an exploded perspective view of the positioning block and the moving block of the present invention;

FIG. 3 is a schematic plan view showing that the extension of the moving block is received in the positioning slot of the positioning block before the positioning block together with the moving block is working with the inner track, the outer track and the mediate track;

FIG. 4 is a schematic view showing the extension is kept outside the arcuate slot of the mediate track by both the protrusion of the mediate track and a stop of the positioning block;

FIG. 5 is a schematic view showing that the extension is received in the arcuate slot after the stop is forced to deform;

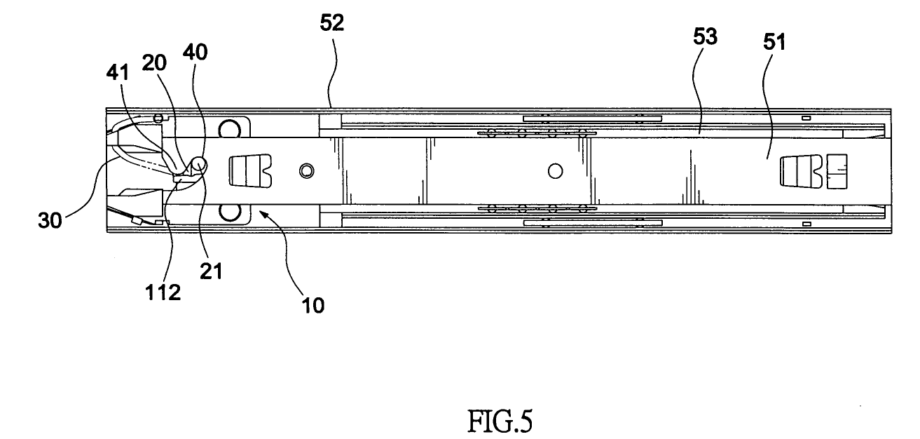

FIG. 6 is a schematic view showing that the extension is still received in the arcuate slot when the mediate track is moved relative to the inner track;

FIG. 7 is a schematic view showing that the extension is forced to be received in the positioning hole by the protrusion of the mediate track; and

FIG. 8 is a schematic view showing that when the mediate track is moving relative to the inner track, the arcuate track is about to make the extension move out of the positioning hole and be slidable in the positioning slot.

### DETAILED DESCRIPTION OF THE PREFERRED EMBODIMENT

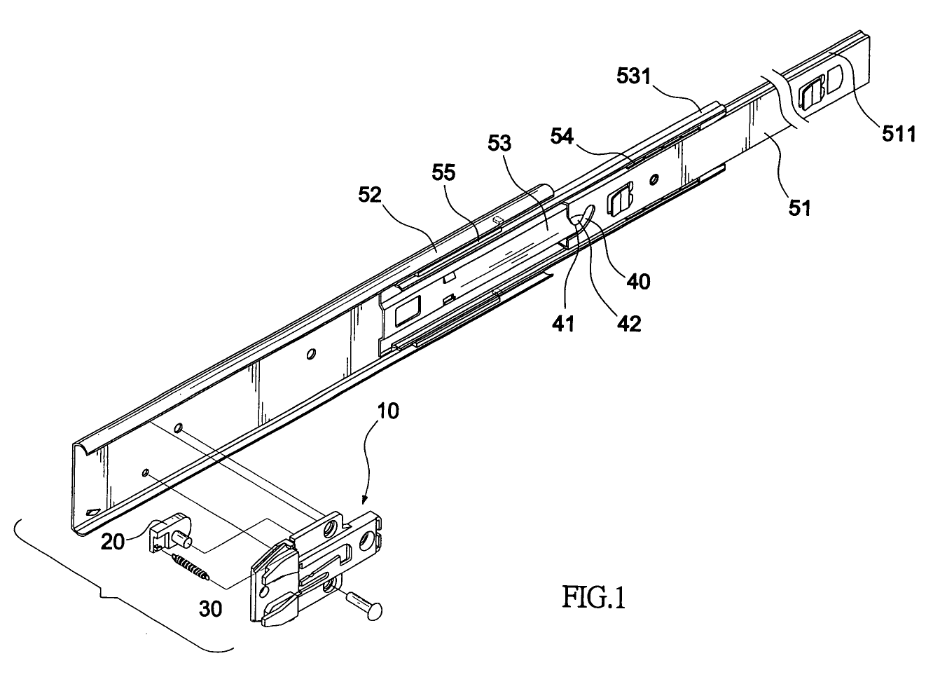

With reference to FIG. 1, the track positioning device in accordance with the present invention includes an inner track (52), an outer track (53) and a mediate track (51), wherein the inner track (52) has a U-shaped cross section, the outer track (53) and the mediate track (51) both have a sliding recess (531,511) respectively defined in opposite side faces of the outer track (53) and the mediate track (51) such that after sliding blocks (54,55) are respectively and oppositely received in the sliding recesses (511,531) of the mediate track (51) and the outer track (53), and the sliding block (54) is sandwiched between the mediate track (51), and the sliding block (55) is sandwiched between the inner track (52) and the outer track (53), both the outer track (53) and the mediate track (51) are slidable relative to the inner track (52) which is securely mounted on opposite sides of a drawer (not shown). The aforementioned paragraph describing the interrelationship among the inner track (52), the outer track (53) and the mediate track (51) describes only the conventional structure of a track device for a drawer, which can not provide an effort saving and convenient track positioning effect.

To provide the required effort saving and convenient track positioning effect, a positioning block (10) and a moving block (20) are provided.

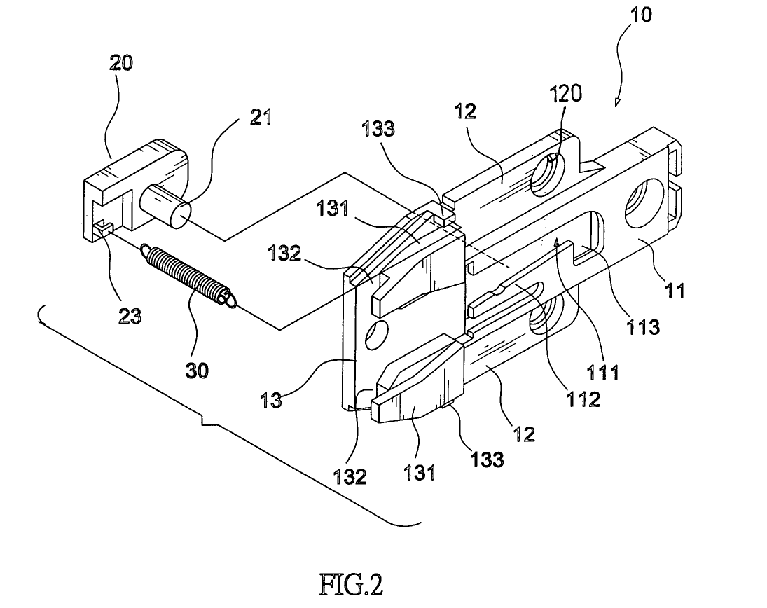

With reference to FIG. 2, the positioning block (10) includes a body (11) with a positioning slot (111) defined therein, two opposite wings (12) respectively formed on a side face of the body (11) and an extending plate (13) formed to connect to both of the wings (12). Each wing (12) has a mounting hole (120) to allow a securing element such as a screw or a rivet to extend through the mounting hole (120) and into the inner track (52) to firmly connect the positioning block (10) to the inner track (52). A stop (112) made of a resilient material i.e. plastic, is formed and extended into the positioning slot (111). A positioning hole (113).is defined in the body (11) to communicate with the positioning slot (111). The extending plate (13) has two plates (131) respectively formed on opposite sides of the extending plate (13) and thus a guiding recess (132) is defined between the plate (131) and the extending plate (13). Two first hooks (133) are respectively formed on opposite sides of the extending plate (13).

The moving block (20) has an extension (21) corresponding to the positioning slot (111) and the positioning hole (113), and a second hook (23) formed on a side of the moving block (20). A spring (30) is provided between the positioning block (10) and the moving block (20) and has a first distal end to be securely connected to one of the first hooks (133) and a second distal end to be securely connected to the second hook (23) via the guiding recess (132).

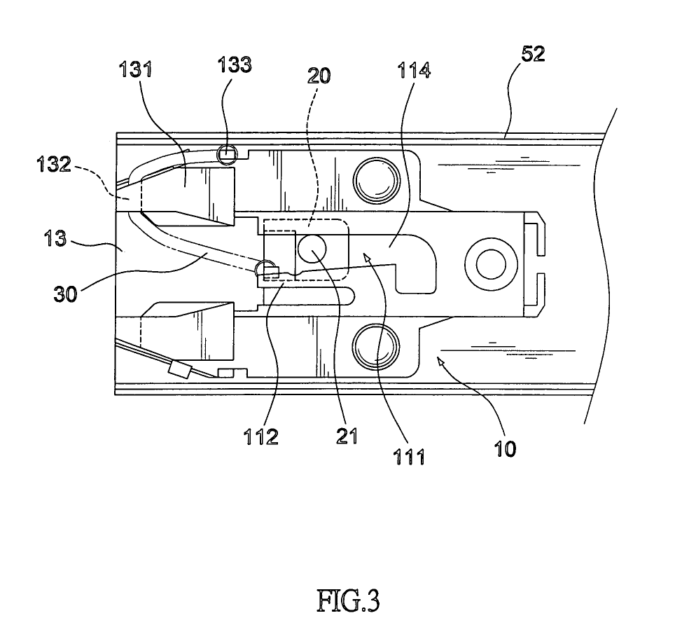

With reference to FIG. 3, when the track positioning device of the present invention is to be assembled, the positioning block (10) is securely connected to the inner track (52) via riveting through the two mounting holes (120) of the wings (12) while the moving block (20) is sandwiched between the inner track (52) and the positioning block (10) with the extension (21) of the moving block (20) extending into the positioning slot (111) of the positioning block (10). Furthermore, one distal end of the spring (30) is securely connected to one of the first hooks (133) and the other distal end of the spring (30) is securely connected to the second hook (23) of the moving block (20) via the guiding recess (132).

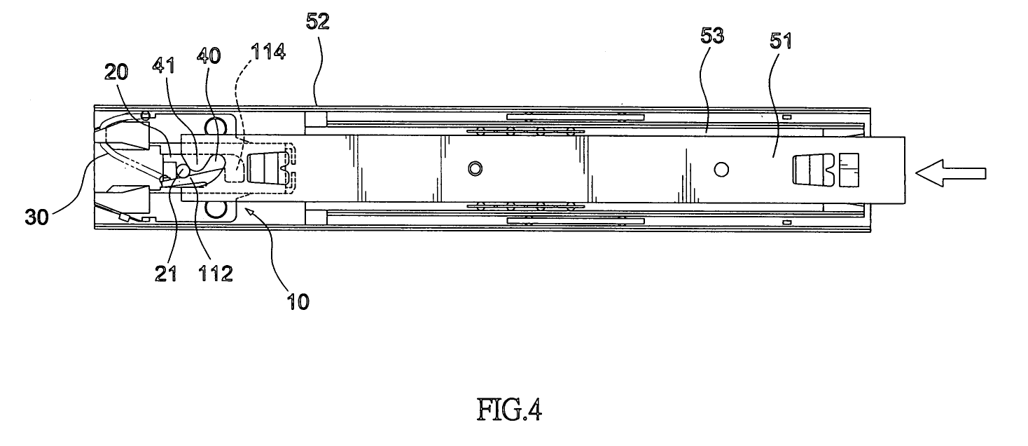

With reference to FIG. 4, when the track positioning device of the present invention is first applied to work with the inner track (52), the outer track (53) and the mediate track (51), an arcuate slot (40) of the mediate track (51) is aligned with the positioning slot (111) and has the extension (21) received in the arcuate slot (40). In the meantime, a protrusion (41) formed on a front portion of an inner face defining the arcuate slot (40) abuts the extension (21).

Then, if the mediate track (51) is pushed toward the inner track (52), the protrusion (41) on the front portion of the arcuate slot (40) is able to force the extension (21) to deform the stop (112). With continuous movement of the mediate plate (51) toward the inner track (52), the extension (21) will overcome the resilience of the stop (112) and thus enter the arcuate slot (40) and the positioning slot (111). Thereafter, the extension (21) will stay inside the positioning slot (111) due to the blockage of the stop (112).

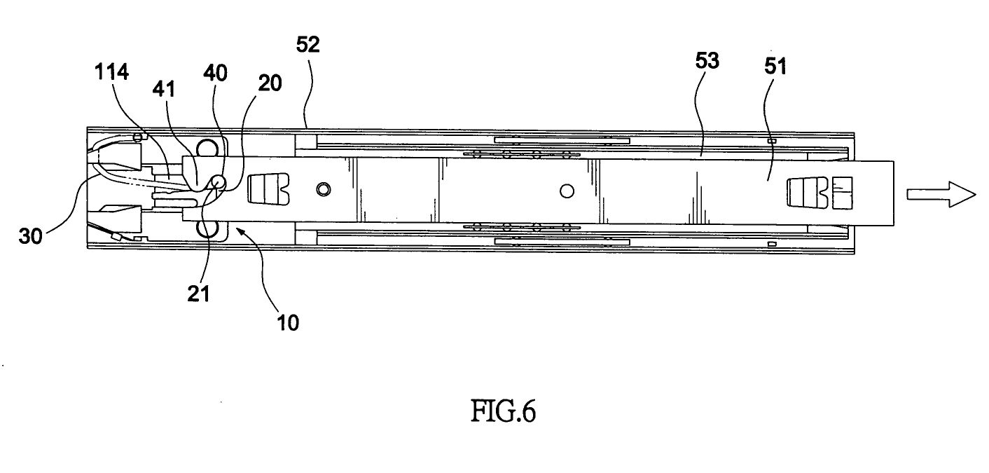

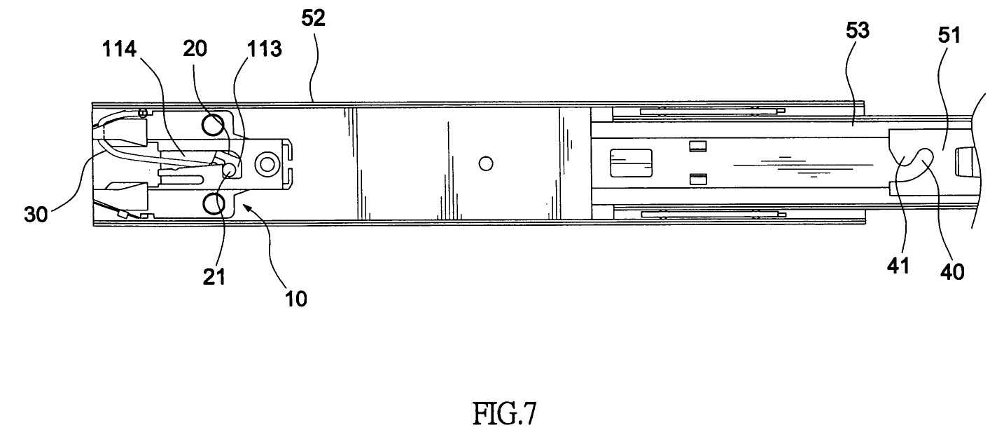

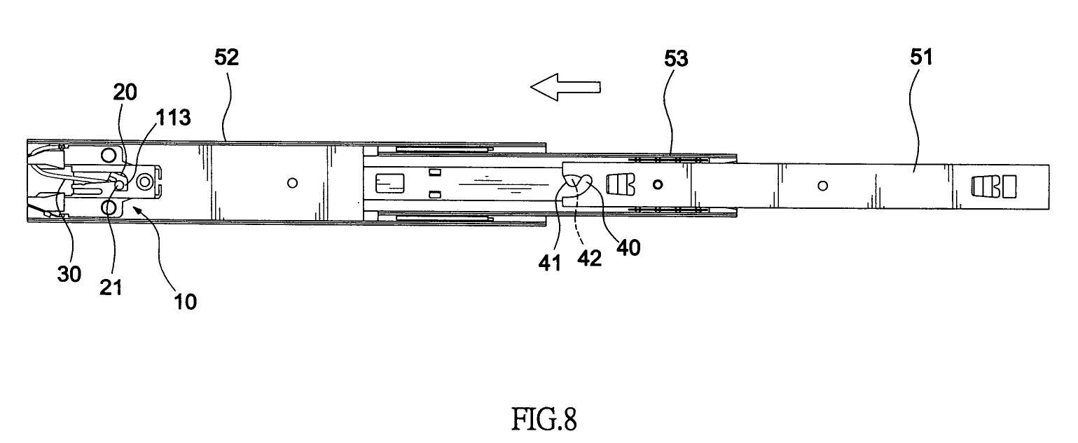

With reference to FIGS. 6, 7 and 8, when the mediate track (51) is forced to move away from the inner track (52), the extension (21) originally received in the arcuate slot (40) will be limited by the periphery defining the positioning slot (111) and because of the protrusion (41), the movement of the extension (21) will be forced by the protrusion (41) to fall in the positioning hole (113). Therefore, when the drawer is pulled to cause the mediate track (51) to move away from the inner track (52), the positioning of the extension (21) in the positioning hole (113) provides a positioning effect to the drawer.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A track positioning device for a drawer having a mediate track, an outer track, and an inner track which is securely connected to opposite sides of the drawer, and the mediate track and the outer track are slidable relative to the inner track, the track positioning device comprising:
a positioning block which includes a body with a positioning slot defined therein, two opposite wings respectively formed on a side face of the body and an extending plate formed to connect to both of the wings, wherein each wing has a mounting hole to allow a securing element extend through the mounting hole and into the inner track to firmly connect the positioning block to the inner track, a stop is formed and extended into the positioning slot, a positioning hole is defined in the body to communicate with the positioning slot, the extending plate has two plates respectively formed on opposite sides of the extending plate and a guiding recess is defined between the plate and the extending plate, two first hooks are respectively formed on opposite sides of the extending plate;
a moving block which has an extension corresponding to the positioning slot and the positioning hole and a second hook formed on a side of the moving block; and
a spring which is provided between the positioning block and the moving block and has a first distal end securely connected to one of the first hooks and a second distal end to be securely connected to the second hook via the guiding recess,
whereby the positioning block is securely connected to the inner track while the moving block is sandwiched between the inner track and the positioning block with the extension of the moving block extending into the positioning slot of the positioning block,
one distal end of the spring is securely connected to one of the first hooks and the other distal end of the spring is securely connected to the second hook of the moving block via the guiding recess, thereby the arcuate slot of the mediate track is aligned with the positioning slot and has the extension received in the arcuate slot, a protrusion formed on a front portion of an inner face defining the arcuate slot abuts the extension,
such that if the mediate track is pushed toward the inner track, the protrusion on the front portion of the arcuate slot is able to force the extension to deform the stop and enter the arcuate slot and the positioning slot, the extension is thus stayed inside the positioning slot due to the blockage of the stop,
when the mediate track is forced to move away from the inner track, the extension originally received in the arcuate slot is limited by the periphery defining the positioning slot and because of the protrusion, the movement of the extension will be forced by the protrusion to fall into the positioning hole, and when the drawer is pulled to cause the mediate track to move away from the inner track, the positioning of the extension in the positioning hole provides a positioning effect to the drawer.
